(19) United States
(12) Patent Application Publication
(10) Pub. No.: US 2026/0078872 A1
(43) Pub. Date: Mar. 19, 2026

(54) MODERATE-PRESSURE LARGE-VOLUME HYDROGEN STORAGE SYSTEM

(71) Applicant: MorningStar Power Inc., Littleton, CO (US)

(72) Inventors: Brian Charles Gibson, Littleton, CO (US); Patricia Ann Gibson, Littleton, CO (US); Verle Lee Binkley, Highlands Ranch, CO (US); David Brooks Pistole, Gainsville, FL (US)

(21) Appl. No.: 18/838,606

(22) PCT Filed: Jun. 11, 2024
(86) PCT No.: PCT/US2024/033462

§ 371 Date: Aug. 14, 2024

Related U.S. Application Data
(60) Provisional application No. 63/507,466, filed on Jun. 11, 2023.

(51) Int. Cl. F17B 1/26; F17C 1/00

(52) U.S. Cl. CPC F17B 1/26; F17C 1/00; F17C 2201/0142; F17C 2201/018; F17C 2201/054; F17C 2223/035

(57) ABSTRACT

A gas storage system which stores large volumes of a gas in a structure at a relatively low to moderate pressure ranging from about 3 atmospheres to about 50 atmospheres. The structure may include a Skeleton with a Skin and may be shaped like a Tipi. The gas may be contained within an interior, collapsible bag. The structure may be part of a water collection system. The Skin may reside within the Skeleton, or it may cover the Skeleton. A low-cost, pressurized gas storage vessel may have a volume greater than 10 m³ and operate between 3 and 50 atmospheres and between −40 and 100 degrees centigrade and have a skin to contain the pressure and limit leakage of the stored gas. The skin may be a flexible, multi-layer membrane.

### REFERENCE TO RELATED APPLICATIONS

This application claims priority from U.S. Provisional Application No. 63/507,466 filed Jun. 11, 2023, the entire contents of which are hereby incorporated herein by reference.

### BACKGROUND OF THE INVENTION

This invention relates generally to systems and methods of storing gases, more particularly to a low- to moderate-pressure, large-volume storage system for gases, and specifically for hydrogen gas.

A known large-volume, gas storage system suitable for hydrogen storage is salt-cavern storage. Such storage is limited to locations with large salt formations in which caverns can be made. Once made, such caverns cannot be moved or relocated. If to be used for a hydrogen power plant, means of transporting the hydrogen must be provided or the power plant located close to the cavern.

Other known storage options are high-pressure, low-volume tanks of metal or composite construction. Small tanks can be portable or easily movable and are proposed for hydrogen powered vehicles. But large-volume, high-pressure storage is very expensive.

### Gas Storage Background, Especially Hydrogen

Googling “Gas Storage” yields results for storing gasoline and natural gas. The natural gas storage methods found include underground storage, a large above-ground cylindrical tank, and large above-ground spherical tanks. After the paid product advertisements, the first link from the Google search was a report on the current amount of natural gas being stored.

The second link in the Google search led to an article on Underground Natural Gas Storage which states, “Natural gas is stored underground primarily in three reservoir types: depleted oil and natural gas fields, salt formations and depleted aquifers. Natural gas may also be stored above ground in refrigerated tanks as liquefied natural gas (LNG).” (https://www.energyinfrastructure.org/energy-101/natural-gas-storage) Regarding Depleted Fields the article notes: “Of the approximately 400 active underground storage facilities in the U.S., about 79 percent are depleted natural gas or oil fields. Conversion of an oil or natural gas field from production to storage takes advantage of existing wells, gathering systems and pipeline connections. Depleted oil and natural gas reservoirs are the most commonly used underground storage sites because of their wide availability.” (Ibid.)

Regarding Salt Formations: “Salt formation storage facilities (also known as caverns and beds) make up about 11 percent of all facilities. These subsurface salt formations are primarily located in the Gulf Coast states. Salt formations provide very high withdrawal and injection rates.” (Ibid.)

And regarding Depleted Aquifers: “Natural aquifers may be suitable for natural gas storage if the water-bearing sedimentary rock formation is overlaid with an impermeable cap rock. They are not part of drinking water aquifers and make up only about 10 percent of storage facilities.” (Ibid.)

Wikipedia, states, “The most important type of gas storage is in underground reservoirs.” It also mentions Liquefied Natural Gas, line packing (storing gas temporarily in the pipeline system at increased pressure), and gasholders. (https://en.wikipedia.org/wiki/Natural_gas_storage)

The Natural gas storage article in Wikipedia led to an article on gasholders which stated: “A gas holder or gasholder, also known as a gasometer, is a large container in which natural gas or town gas (coal gas or formerly also water gas) is stored near atmospheric pressure at ambient temperatures. The volume of the container follows the quantity of stored gas, with pressure coming from the weight of a movable cap. Gas holders now tend to be used for balancing purposes to ensure that gas pipes can be operated within a safe range of pressures, rather than for actually storing gas for later use.” (https://en.wikipedia.org/wiki/Gas_holder)

In describing a gasholder's function, the gasholder article stated: “A gas holder provided storage for purified, metered gas. It acted as a buffer, removing the need for continuous gas production. The weight of the gas holder lift (cap) controlled the pressure of the gas in the mains and provided back pressure for the gas-making plant. They are the only storage method that keeps gas at district pressure (the pressure required in local gas mains).” (Ibid.) The article presents an image of a large above-ground cylindrical tank (a 30,000 m³ blast furnace gasholder at Rautaruukki Steel in Finland).

The google search also found a link to an energy consulting company. Their article focused exclusively on underground storage and discussed the ancillary equipment and considerations required for an underground installation. They, in particular, discussed the need for cushion gas, “A part of the storage volume needs always be filled with gas. This so-called cushion gas is required to maintain sufficient pressure in the storage to allow for adequate withdrawal rates.” (https://www.kyos.com/faq/what-is-a-gas-storage/) Cushion gas and the amount of cushion gas required for the different underground storage methods is discussed in much greater detail in a Federal Energy Regulatory Commission report from 2004. The data is reproduced in TABLE 1.

TABLE 1
Gas Storage Facility Operations¹

| | Cushion to Working | Injection | Withdrawal |
|---|---|---|---|
| Facility Type | Gas Ratio | Period (Days) | Period (Days) |
| Aquifer | 50% to 80% | 200 to 250 | 100 to 150 |
| Depleted Oil/Gas | 50% | 200 to 250 | 100 to 150 |
| Reservoirs | | | |
| Salt Cavern | 20% to 30% | 20 to 40 | 10 to 20 |

¹Source: Analysis of FERC filings in 2004 report (https://web.archive.org/web/20170825102800/https://www.ferc.gov/EventCalendar/Files/20041020081349-final-gs-report.pdf)

Two sources of images of large above-ground spherical metal tanks will be mentioned. First, an article from Marcogaz, a non-profit association representing the European gas industry. The Marcogaz article makes the point, made elsewhere as well, “The main function of gas storage is to smooth seasonal fluctuations in gas demand but also to meet peak daily demand.” (https://www.marcogaz.org/technical-work/infrastructure/storage)

Second, an article advertising level measurement, This article states, “Although natural gas is most frequently stored in underground facilities, aboveground tanks are sometimes used for storage.” (https://www.magnetrol.com/fr/blog/level-measurement-solutions-natural-gas-storage-tanks)

### Hydrogen Storage

Searching more specifically for “Hydrogen Storage” brought up first four sponsored sites. Apparently this is an interesting topic and a number of companies/organizations want us to know what they are doing with hydrogen storage.

The first non-sponsored listing was an overview of the topic from the DOE's Hydrogen and Fuel Cell Technologies Office (HFTO). Their focus is on “developing onboard automotive hydrogen storage systems that allow for a driving range of more than 300 miles while meeting cost, safety, and performance requirements.”

They outlined the basic ways in which hydrogen is stored for automotive purposes: “Hydrogen can be stored physically as either a gas or a liquid. Storage of hydrogen as a gas typically requires high-pressure tanks (350-700 bar [5,000-10,000 psi] tank pressure). Storage of hydrogen as a liquid requires cryogenic temperatures because the boiling point of hydrogen at one atmosphere pressure is −252.8° C. Hydrogen can also be stored on the surfaces of solids (by adsorption) or within solids (by absorption).” (https://www.energy.gov/eere/fuelcells/hydrogen-storage)

The HFTO also has a set of Hydrogen Delivery pages. These pages discuss hydrogen storage more generally and emphasize, “Hydrogen is not just the smallest element on earth, it is also the lightest—as a point of comparison, the mass one gallon of gasoline is approximately 2.75 kg where one gallon of hydrogen has a mass of only 0.00075 kg (at 1 atm pressure and 0° C.). In order to transport large amounts of hydrogen it must be either pressurized and delivered as a compressed gas, or liquefied.” (Ibid.) (https://www.energy.gov/eere/fuelcells/hydrogen-delivery)

Their On-Site and Bulk Hydrogen Storage page states: “On-site hydrogen storage is used at central hydrogen production facilities, transport terminals, and end-use locations. Storage options today include insulated liquid tanks and gaseous storage tanks.” (https://en.wikipedia.org/wiki/Hydrogen_storage) The page describes the “four types of common high pressure gaseous storage vessels.”

Regarding liquid hydrogen the page states: “Cryogenic liquid storage tanks, also referred to as dewars, are the most common way to store large quantities of hydrogen. Super-insulated low pressure vessels are needed to store liquid hydrogen at −253° C. (−423° F.). The pressure of liquid hydrogen is no more than 5 bar (73 psig). Regardless of the quality of the insulation, however, some heat will reach the tank over time and cause the liquid hydrogen to boil. The result is that hydrogen gas accumulates at the top of the liquid tank and causes the pressure inside the tank to increase. To keep the pressure from rising above the limits of the tank, the gaseous hydrogen must be vented from the liquid tank and either released or recompressed by a boil-off compressor to be stored as gaseous hydrogen.” (Ibid.)

The page also discusses underground storage: “A national hydrogen infrastructure could require geologic (underground) bulk storage to handle variations in demand throughout the year. In some regions, naturally occurring geologic formations, such as salt caverns and aquifer structures, might be used, while in other regions, specially engineered rock caverns are a possibility. Geologic bulk storage is common practice in the natural gas industry and there are four existing salt caverns used for hydrogen storage today. The use of geologic storage for hydrogen used in fuel cell electric vehicles requires further investigation into the possible impurities that could be introduced by underground storage.” (Ibid.)

Wikipedia also has a “Hydrogen Storage” page which states: “Several methods exist for storing hydrogen. These include mechanical approaches such as using high pressures and low temperatures, or employing chemical compounds that release H₂ upon demand. While large amounts of hydrogen are produced by various industries, it is mostly consumed at the site of production, notably for the synthesis of ammonia. For many years hydrogen has been stored as compressed gas or cryogenic liquid, and transported as such in cylinders, tubes, and cryogenic tanks for use in industry or as propellant in space programs. Interest in using hydrogen for on-board storage of energy in zero-emissions vehicles is motivating the development of new methods of storage, more adapted to this new application. The overarching challenge is the very low boiling point of H₂: it boils around 20.268 K (−252.882° C. or −423.188° F.). Achieving such low temperatures requires expending significant energy.” (https://en.wikipedia.org/wiki/Hydrogen_storage)

Wikipedia also has a separate article devoted to Underground Hydrogen Storage which states: “Large quantities of gaseous hydrogen have been stored in caverns for many years. The storage of large quantities of hydrogen underground in solution-mined salt domes, aquifers, excavated rock caverns, or mines can function as grid energy storage, essential for the hydrogen economy.” (https://en.wikipedia.org/wiki/Underground_hydrogen_storage, references omitted)

The search also brings up an article from Mitsubishi championing their underground storage efforts: “One of the world's largest renewable energy storage hubs, the Advanced Clean Energy Storage Hub, is currently under construction in Utah in the US. This hub will bring together green hydrogen production, storage and distribution to demonstrate technologies essential for a future decarbonized power grid. Mitsubishi Power, a power solutions brand of Mitsubishi Heavy Industries (MHI), is providing the technology for producing hydrogen from renewable energy, which will then be stored in a series of salt caverns. They will be constructed deep underground in a salt dome that covers more than 4,800 acres. Each cavern will be about 67 meters in diameter and 580 meters in height.” (https://spectra.mhi.com/4-ways-of-storing-hydrogen-from-renewable-energy)

### Pressure

The cost-effectiveness of an energy storage system depends in part on the round-trip efficiency in storing and retrieving the energy. In regard to that it should be noted that pressurizing and depressurizing a gas requires energy. In fact, compressed gases are a means of storing energy. If, however, that energy of pressurization is not recovered, that reduces the efficiency of the energy storage system. Even if some of the energy of pressurization of hydrogen gas is recovered, some efficiency is still lost relative to the chemical energy of hydrogen being stored. This point is underscored in a 2019 The Chemical Engineer article, “The Unbearable Lightness of Hydrogen,” states “One of the main issues with compression of hydrogen is that it carries a large energy penalty—the energy used in compressing hydrogen to 35 MPa is 14.5 MJ per kg of hydrogen, and if compressed to 70 MPa, then it is 18 MJ per kg of hydrogen. This would mean that, if stored at 70 MPa, about 15% of the energy contained in the hydrogen is spent compressing it!” (https://www.thechemicalengineer.com/features/the-unbearable-lightness-of-hydrogen/)

### SUMMARY

When cost is (almost) no object, a large amount of energy is needed, and volume needs to be minimized, e.g., when hydrogen is used as rocket fuel, it is stored as a cryogenic liquid at 20° K.

When cost is more of an object, a lesser amount of energy is needed, and volume/mass still needs to be minimized, i.e., automobiles and other ground vehicles, hydrogen is generally stored in tanks as a compressed gas at up to 700 bar.

In some cases the volume/mass/energy needs for such vehicles, e.g., mine cars, outweigh the cost constraints and hydrogen is stored in materials such as vanadium.

For shipping and on-site storage of hydrogen to fuel automotive use, hydrogen is generally stored is tanks as a compressed gas. Sometimes the quantity stored can justify storing hydrogen as a liquid, especially if storage is for a short-enough time to minimize boil-off.

When large amounts of energy are needed and cost is the driver, e.g., using hydrogen in a electric power plant, the only means currently being explored/used is underground storage in salt caverns. Locations for such storage are limited to the relatively rare sites where the needed geologic features, i.e., salt domes, exist.

Structures similar to gasholders are not being used to store hydrogen. Gasholders operated at near ambient pressures and used relatively complex systems to maintain their pressure. They were not generally used for storage as such, but were used to maintain system pressure. In any case, above-ground structures have generally been considered too expensive to store large volumes of hydrogen.

### The Challenge—Energy Storage

Energy storage has been called the Holy Grail of energy.

Since mankind first harnessed fire, and perhaps before, the development and employment of energy systems has been a major theme of human existence. In our current era the side effects of harnessing conventional fire-based energy systems are viewed by many as a threat to human existence. We are blessed with other sources of energy, abundant sources of energy, the sun and the wind, being most relevant here. These sources of energy are likewise ancient. Reptiles warmed themselves in the sun before mankind even existed. Mankind has been harvesting energy from the wind at least as far back as the invention of the sail.

One of the most dramatic technological developments of the last half century has been the decrease in the cost of systems able to harvest power from the sun and the wind, and the resulting wide-scale deployment of such systems.

But we want power-on-demand. The rotation of the earth interrupts the ability of ground-based systems to harvest energy from the sun. Clouds also introduce variability into our ability to meet our ongoing power use through sunlight. The energy available to be captured from the wind is likewise variable. On the other hand, our energy consuming systems are geared toward more or less continuous provision of power and the ability to increase or decrease that usage on demand.

It has long been recognized that to properly marry our energy consuming systems with intermittent power sources such as the sun and the wind, we need to have a means to economically store energy and then readily convert it back into the power we need to satisfy our instantaneous demands.

The economics of energy storage systems rest on the capital cost to build such systems, the costs to manufacture and operate such systems, and their round-trip efficiency in storing and then retrieving energy.

Because energy storage is so important, it would be impossible to provide an exhaustive review of all the schemes proposed to store and retrieve energy. Currently the most deployed means for storing energy is pumped hydro-power. But the use of pumped hydro-power is limited by the availability of sites suitable for large water reservoirs at different elevations.

Therefore battery-based energy storage is the means used by most newly deployed energy storage systems. The development of battery systems is being pursued vigorously, and there is great reason to expect that technology developments will lead to a rapid ability to employ battery storage on a vastly greater scale. Currently the batteries of choice are lithium-based, their production is limited by the supply of lithium and manufacturing capacity, and they have shortcomings in terms of ability to retain their ability to store energy over multiple charging/discharging cycles and the risk of catastrophic failure from the growth of internal dendrites. Liquid-metal and other battery types are promising candidates to ultimately supplant lithium batteries in industrial scale applications, but liquid-metal batteries are only now being introduced into actual use, and so it would be premature to conclude that no other means of energy storage will ever be needed.

Another means to store energy is to produce fuel which can later be oxidized, producing power-on-demand. Because hydrogen when oxidized produces water, a carbonless compound, hydrogen is the most-touted clean fuel.

Much research has gone into the three elements of using hydrogen for energy storage: producing the hydrogen, storing the hydrogen, and unleashing the stored energy through oxidizing the hydrogen.

What is needed is a cost effective, low to moderate pressure system of gas storage applicable to hydrogen gas.

### SUMMARY OF THE INVENTION

The present invention is directed to systems and methods which provide for storage of gases such as hydrogen gas, or provides for the storage of large volumes of a gas, such as hydrogen, at relatively low pressures. Such a system has the potential advantages of being relatively low cost and also relatively easy to relocate.

In one embodiment the system for gas storage includes a generally cone-shaped bladder or bag which may be supported by a rigid, skeletal, support structure. The bladder material is flexible but not stretchy. The skeletal structure may be an exoskeleton or an endoskeleton. The bladder may be a flexible membrane that can be inflated with a gas such as hydrogen. The bladder and skeletal structure may resemble a tipi. The system may include a rounded depression in the earth ringed with a raised berm.

The system may include a second, inner bladder which may hold a first gas, while the volume between the two bladders holds a second gas. This embodiment may permit the system to hold a less than full quantity of the first gas at a predetermined pressure and to fill or release the first gas while maintaining a constant system pressure via the second gas. The system may be reversed, so that the first gas is in the space between the two bladders and the second gas is in the inner bladder.

In other embodiments, the system may include means to introduce water into the bladder to maintain gas pressure when the bladder is not filled to capacity with gas.

In other embodiments the system may include ballonets.

In another embodiment, a mnoderate-pressure, large-volume, gas storage system suitable for hydrogen storage may include a polyhedral bladder instead of a tipi-shaped bladder.

While the bladder is the main inventive feature of the system, many other accessories may be added to the system to achieve a particular use or outcome. For example, the system could include one or more of the following: a water collection or supply system, an electrolyzer to generate hydrogen from water, a fuel cell to generate electricity from hydrogen, a hydrogen dispensing system, a hydrogen-burning power plant, and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a partially fragmented elevation view of a first embodiment of the invention;

FIG. 2 is a partially fragmented sectional elevation view of the first embodiment of the invention;

FIG. 3 is a perspective view of a “Brella” component of the invention;

FIG. 4 is a cross-section top plan view of a “Brella” with ballonets;

FIG. 5 is a perspective view of a second embodiment;

FIG. 6 illustrates one deployment of the second embodiment; and

FIG. 7 illustrates close-packing of multiple copies of the second embodiment.

### DETAILED DESCRIPTION

This disclosure focuses on the issue of storage of gases, such as hydrogen. It should, however, be noted that the gas storage system outlined here is generally applicable to any gas and is not limited to use only with hydrogen. It may be that other gases, e.g., oxygen or natural gas, are so easily obtained that their value may not justify the cost of storage, or at least not storage using the system described in this disclosure.

Storage systems have to satisfy several requirements including safety, immunity from adverse reaction to the material being stored, and leakage. The storage vessel should be leakproof, i.e., leakage must be so little that there is negligible effect on the cost of storing hydrogen by the need to replace hydrogen lost through leakage. And certainly the storage vessel also must not leak enough to create a safety hazard! Perhaps the most significant factor in deciding whether a storage solution is feasible is simply the cost.

Hydrogen at earth-normal pressures and temperatures is H₂, a gas. H₂, having a molecular weight (mass) of just 2 is the lightest of gases. And hydrogen doesn't liquify until roughly 20° K (−423° F., −253° C.). So to store a lot of hydrogen (and its associated energy as a fuel), one has to have either a large volume or high pressure. If cost is not a significant object, such as in using hydrogen to fuel a rocket or maybe even a car, the high price of using a lot of energy to liquify hydrogen may be justified. But in the application of trying to store hydrogen for providing utility electricity, the process of liquefaction would be so costly as to be prohibitive.

The volume-pressure tradeoff in storing hydrogen as a gas is not so easily resolved. The energy, and associated cost, used to pressurize a gas argues against high-pressure storage systems. On the other hand, compressed gas is itself a means of energy storage, and so a high-pressure hydrogen storage system could be constructed to both recover much of the energy used to compress the hydrogen and then use the hydrogen as a fuel. But such a storage system introduces many complications, and complications tend to increase cost and reduce reliability; nonetheless it is possible that such a system could be successful.

This application is, however, directed toward a relatively low- to moderate-pressure, large-volume hydrogen (energy) storage system in the belief that such a system will in many cases be the low-cost sweet spot. Among other things, simplicity, and thus low cost, will favor a system where the storage pressure fits well with the other components of the energy system, namely the means for producing hydrogen, typically an electrolyzer (sometimes spelled electrolyser), and the means for converting the hydrogen into electricity, typically a fuel cell. Another factor which may favor a relatively large, moderate-pressure container is the possibly lower construction cost to build a large moderate-pressure storage container versus a smaller high-pressure container.

Before moving on to describe the inventive concept disclosed here, it is appropriate to note that there already exists a relatively low-cost means of storing hydrogen at certain locations. Those locations are in salt domes, such as are used by the ongoing Advanced Clean Energy Storage (ACES) project in Utah. Such geological features enable one to create enormous caverns in the salt in which one can store huge quantities of hydrogen.

This salt cavern arrangement has a number of advantages, but those advantages do not include the ability to store hydrogen anyplace one desires. One is limited to locations that have suitable salt formations. This means one must then take the resulting energy and pipe it to wherever it is needed. There already exists substantial infrastructure to transport electrical energy to much of the lower 48 states in the United States, but not all places. ACES and other salt-formation-based projects will not generally provide improved access to electricity to more remote locations in the lower 48 states, to Alaska, or to Hawaii or other islands isolated from the grid. Nor will salt-formation-projects be generally able to improve access to electricity to many remote regions throughout the world. The invention described here can significantly enable access to electricity in remote and isolated regions which may be beyond economical connection to an existing electrical grid.

Also, although we have described hydrogen as a fuel, up until now we have focused on its use as a fuel to generate electricity at a power plant. Hydrogen, of course, is also being explored as a transportation fuel. Vehicles using hydrogen as a fuel must have locations, a lot of locations, to use as fuel stations at which vehicles may obtain the fuel they need. Hydrogen can be transported from central hubs like ACES via pipeline and tankers to fuel stations, but that involves expansion or conversion of pipeline infrastructure and the employment of large fleets of tankers. A distributed system of smaller hydrogen generators may reduce infrastructure stress, may lower costs, and may also produce a more robust, resilient, and reliable future hydrogen infrastructure.

Likewise, especially in light of the increased opposition to adding new transmission lines to our electrical grids, a distributed system of smaller hydrogen storage power plants may be the key to improving our electrical infrastructure.

Distributing electrical generation through relatively inexpensive and relatively small hydrogen-storage power plants may improve the resilience and reliability of electrical systems in the United States and throughout the world.

The invention disclosed herein is a gas storage system which will be used to store hydrogen and may also be used to store other gases. The design is driven by cost, which needs to be competitive with salt caverns, the current gold standard for low-cost storage of industrial-scale quantities of hydrogen.

### First Embodiment

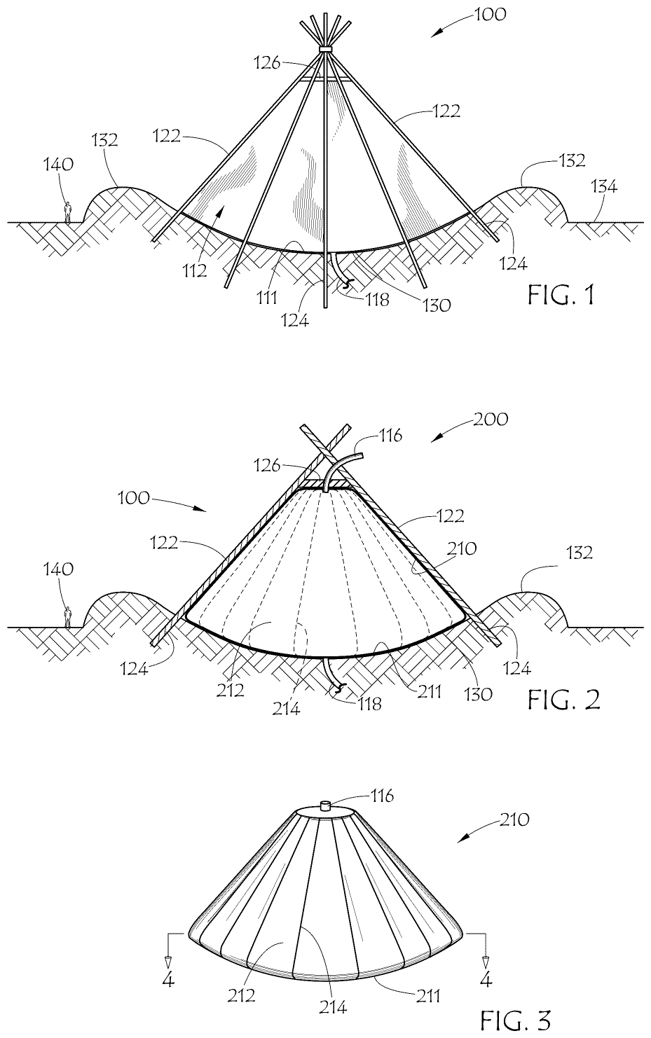

FIG. 1 illustrates a first embodiment of the invention which looks like a giant tipi. The principal design driver for the Native American tipi was low cost. As is often the case, low cost was achieved through simplicity. The tipi was a skeletal structure covered by a skin, often literal animal skins.

The other major design driver for the Native American tipi was that it be portable. Except for its smallest implementations, this invention is not intended to be portable. This invention is nonetheless intended to be inexpensive to construct, and unlike salt cavern storage which must be located within a salt dome, this invention can be constructed essentially anywhere.

A typical steel storage tank stores gases at hundreds of atmospheres. Underground storage may be at pressures as high as two hundred atmospheres. By contrast this invention stores gas at relatively low pressures, preferably somewhere between 5 and 20 atmospheres. There is no explicit limitation on the minimum pressure for this invention, but the design goal is that the pressure be at least 5 atmospheres, and the existence of bicycle tires suggests that low-cost structures can be built to withstand such pressures. There is likewise no explicit limitation on the maximum pressure for this invention. The trade between increasing cost for a higher pressure structure and the incremental value of storing additional hydrogen will help determine how high a pressure will be used. Additional factors will also play in determining the pressure at which the storage system will operate: The pressurization/depressurization energy losses favor lower pressures. Ready compatibility with existing electrolyzers and fuel cells also favors keeping the pressure relatively low. The design sweet spot is probably less than 20 atmospheres.

The invention is intended to store power at utility-level scales, i.e., large quantities of hydrogen. It is not yet known how big this storage system can be built and there is no inventive limitation as to the size. The Applicant, MorningStar Power, Inc. (“MorningStar”) has envisioned producing models in three sizes, 50-m tall (volume ˜125,000 m³), 50-feet tall, and 5-m tall. The actual size of the storage structure will depend on design drivers such as construction costs, the power available to generate hydrogen, the electrical loads, and the time over which stored energy will be drawn from the system, e.g., a system designed to supply energy overnight until solar energy is available in the morning, a common grid-oriented design goal has different storage needs than a system designed to provide a remote, not-connected-to-the-grid community with enough storage to meet its energy needs over the entire year.

The inventive detail is best presented by walking through the embodiment shown in FIG. 1. The principal structure of this embodiment 100 look like a giant tipi and for this reason is called the “Tipi” herein.

In FIG. 1, the Tipi 100 may be 50-m tall. For scale, a stick figure of a person 140 is shown on the left side of the figure. Other important features of the system include the “Brella” 210, the “Cistern” 130, and the “Solar Shell” (to be described below). All may complement the Tipi to help form a power plant.

### The Tipi

A Native American tipi is a largely conical structure with the width of the tipi being comparable to its height. So is the Tipi. And like a tipi, the Tipi it is constructed out of two major components, a set of structural elements 122 which create a Skeleton that determines the outline of the Tipi and a covering, a “Skin” 112, which may enclose the Tipi or which may be within the Skeleton.

In function the Tipi contains and protects a precious commodity, the stored hydrogen, from the elements, much as the tipi contained and protected a precious commodity, Native American people, from the elements. While this application focuses on the storage of hydrogen, the storage system discussed could be used for any gas. Another embodiment is to store oxygen, the other product of electrolyzing water, and an embodiment envisions storage triplets of these storage systems, storing in proportion to the gases generated, hydrogen in two Tipi structures and oxygen in the third.

In containing hydrogen, the Tipi's primary function is provide the strength necessary to create a pressure vessel, much in the way that a bike tire has the strength to hold in the air which pressurizes the tire. The Tipi forms a pressure vessel, and so, unlike a Native American tipi, the Tipi 100 has a bottom 111 so as to completely enclose the stored hydrogen. FIG. 1 shows the bottom 111 of the Tipi as approximately a spherical section with no structural elements across the span of the base. The bottom might instead be a mirror image of the top of the Tipi or some other shape, and might incorporate structural elements to add strength to contain the pressure pushing out on the base.

The Tipi can also serve as part of a water collection system. Water is the feedstock for electrolysis which splits water into hydrogen and oxygen. And water is a scarce resource in many places, including the American West. So, to at least partially address the need for water, the Skin 112 of the Tipi 100 can be water resistant so that any rain or snow that falls on the Tipi slides down the Tipi and into the Cistern 130 underneath the Tipi where it is pumped away through water channel 118 and/or stored for use in the electrolyzer.

A conventional tipi used wooden poles as its principal structural elements, the legs of the tipi. In the embodiment of FIG. 1, the principal structural elements of the Skeleton, the legs 122 could be constructed using structural steel (or other metal) I-beams or structural composites. There can be a wide range in the number legs. Native American tipis commonly use around 15 poles. MorningStar has envisioned that its 50-m model can use 32 legs, 12 legs for the 50-foot model, and only 3 legs for the 5-m model, thus, large, medium and small models, respectively.

The Tipi may have the legs inclined at about a 45-degree angle. While there is a fairly wide range of angles which can enclose approximately the same volume of hydrogen per area of the Skin (a figure of merit, a structure which encloses more hydrogen per area of Skin will be proportionally less costly since the cost of the Skin will generally be proportional to the area of Skin), the relatively steep angle of 45 degrees was chosen so that the structure is sufficiently peaked that even wet sticky snow will tend to slide easily down the side of the Tipi.

The embodiment of FIG. 1 of the Tipi 100 has an exoskeletal structure 122, i.e., the Skin 112 is placed on the inside of the skeleton. This is opposite of a traditional Native American tipi which uses an endoskeletal structure, i.e., the covering is placed on the outside of the skeleton. The Native American tipi was designed such that when wind blows against a tipi, the covering is pushed against a hard stop, the skeletal structure. The Tipi could also use an endoskeletal structure, and the Tipi also experiences wind, but the inside of the Tipi is pressurized, and so the baseline embodiment of the Tipi has the Skin inside the Skeleton so that the internal pressure pushes the Skin against the skeletal hard stop.

Some additional features of the of the Tipi 100 are shown in FIG. 1. The legs join at the top of the Tipi by being bolted to a steel platform 126, the “Top Floor”, a regular polygon with as many sides as the Tipi (or it may be a circular platform).

Hydrogen may be piped in and out of the Tipi at ground-level corners. The choice of where to insert and extract hydrogen is not a limitation on the invention. It could be anywhere including the gas connection 116 near the Top Floor 126.

The Top Floor 126 may also have an access port to the space between the exterior of the Brella 210 and the interior of the Tipi 100. A hydrogen detector may be connected to that access port to detect leaks in the Brella, or mounted elsewhere.

The Skin 112 of the Tipi 100 may be a heavy, water-repellent fabric.

The skin for large-model Tipi 100 may be constructed out of 32 separate heavy, water-repellent fabric covered sides 112 (arbitrarily named “Jims” herein), where the sides 112 are glued to the inside edges of corresponding legs 122.

The gaps between the Jims may be sealed with a line of heavy water-repellent fabric glued to the portion of the I-beam leg closest to the Brella on the outward facing I-beam surfaces that are outward facing on the side of the I nearer to the Brella.

The adjacent I-beams may be bolted together using steel pieces that form a stair-step or ladder arrangement along the entire length of the leg (not shown). The lower ends 124 of the legs 122 may be embedded or anchored in the ground for stability and to counteract the buoyancy of the hydrogen gas.

Two variant embodiments may be mentioned. (1) 3D-printed Skeletons for the Tipis may introduce many potential advantages. (2) Tipi Skin based on metal sheeting similar to metal roofs may be useful. Developing bracing to strengthen the metal sheeting to achieve the desired pressures may be relatively straightforward. Alternately, metal films may complement the coated fabric to improve impermeability or other properties.

Development effort may be devoted to all three variants. In selecting which variants go to market, the factors considered will include material costs, construction costs, maintenance costs, durability, pressure containment capability, availability of supplies and construction equipment, design flexibility, and development time. It may be that more than one variant will go to market. It may be that different variants may be better suited for different size models. And it may be that containment structures which don't look like tipis will be adopted.

### The Brella

Conceivably the Tipi 100 alone could serve as the storage vessel for the hydrogen, much as most modern automobile tires are tubeless. And we do not teach against an embodiment which uses the Tipi alone as the pressure vessel. In fact, we claim such an embodiment.

But this storage vessel has to be essentially leakproof to hydrogen, be immune to adverse effects from reacting with hydrogen, protect from the elements, be strong enough to hold its pressurized gaseous contents, and we're even asking it to shed water. An embodiment of this hydrogen storage system is designed to satisfy these functional requirements through the use of two components as illustrated in FIG. 2 and FIG. 3. The Tipi 200 will protect from the elements, shed water, and be strong enough to hold its pressurized gaseous contents, just as described in FIG. 1. An inner component, the Brella 210, much like the tube inside a bicycle tire, will address the specialized requirements of being immune to adverse effects from reacting with hydrogen, and being leakproof against the hydrogen stored within. We named this inner component the “Brella” because it resembles an inverted umbrella. The mockup of the Brella shown in the photo in the provisional application was created using an inverted umbrella.

When inflated and pressurized the Brella 210 fills the space inside the Tipi 100. Like the Tipi, the Brella has a bottom 211 corresponding to the cloth cover of the umbrella pictured, and sides 212 which when inflated are supported by the sides of the Tipi. The sides of the Brella are shown as clear plastic in the mockup. The Brella may require multiple strips of material with multiple seams 214 to form the sides 212. The mockup shows only approximately ⅝ of the sides in order to more clearly show the interior volume which the inflated Brella will enclose when filled with hydrogen. While the Tipi may have structural elements in its bottom, an actual Brella will not have ribs in the bottom; the Brella will fully inflate without ribs since its interior is at a higher pressure than the ambient atmosphere. Further, unlike an umbrella, a Brella will not have a central shaft. A Brella is essentially a bag or bladder with no associated structure, it simply inflates as a closed laundry bag would inflate if gas were pumped into it. While the Brella could be elastic and stretch to fill the volume within the Tipi like an inner tube or like a rubber bladder, the preferred embodiment does not have any significant elastic property, and there is not intended to be any pressure drop from the inside to the outside of the Brella. All the pressure of the gas inside the Brella goes through the walls of the Brella and is supported by the Tipi. Again this is not a limitation, the Brella could be elastic like an inner tube, it could even be intended to support a pressure drop across its walls and relieve some of the pressure carrying requirements of the Tipi. The Brella may be made of a light plastic film similar to the plastic shown in the picture, since it can be supported by the Tipi.

Use of a second component, the Brella, brings an extra advantage to the system over the use of the Tipi alone as a storage vessel. The Tipi has essentially a fixed shape and it encloses essentially a fixed volume. So if one were to fill the Tipi directly with a gas to be stored without using a Brella, a collapsible inner liner, the gas to be stored would mix with the gas already in the Tipi and the purity of the gas being introduced would be degraded by the gas already present. One could take pains to evacuate the inside of the Tipi before beginning to introduce the gas to be stored, but the Brella approach is simpler and easier. A collapsed Brella encloses essentially zero volume, and thus has very little residual gas to degrade the purity of the gas being stored. The Brella is designed to inflate as it is filled with hydrogen. Thus, this design using a Brella preserves the purity of the gas being stored.

Ballonets within the Brella:

A lighter-than-air airship has bags of light gas, helium or hydrogen, that float the ship. Ballonets are gas bags within these main bags that can be filled with air or more specific gases. The gas inside the ballonet is heavier than the gases used to float the ship and so by filling or emptying ballonets in various parts of the airship, e.g., the front and the back, ballonets help the operator balance the ship.

It is envisioned that the Brella has two shapes: (1) Its shape when fully inflated which conforms to the inside of the Tipi; and (2) Its shape when fully collapsed. It is intended to tie the corners of the Brella to the corners of Tipi, so before inflation the Brella will be stretched across the bottom of the Tipi. The Brella will nonetheless have folds. Also after being manufactured and before being installed in the Tipi, the Brella will likely be deliberately folded for handling purposes. All these folds are probable weak points in the structure of the Brella, but the Brella need only unfold once when it is initially filled, and so those folds (and the remainder of the Storage System) will not be stressed repeatedly except to the extent the entire Storage System, Brella and Tipi, breathes, i.e., expands and contracts slightly, as the pressure of the interior hydrogen goes up and down during operation over the life of the Storage System.

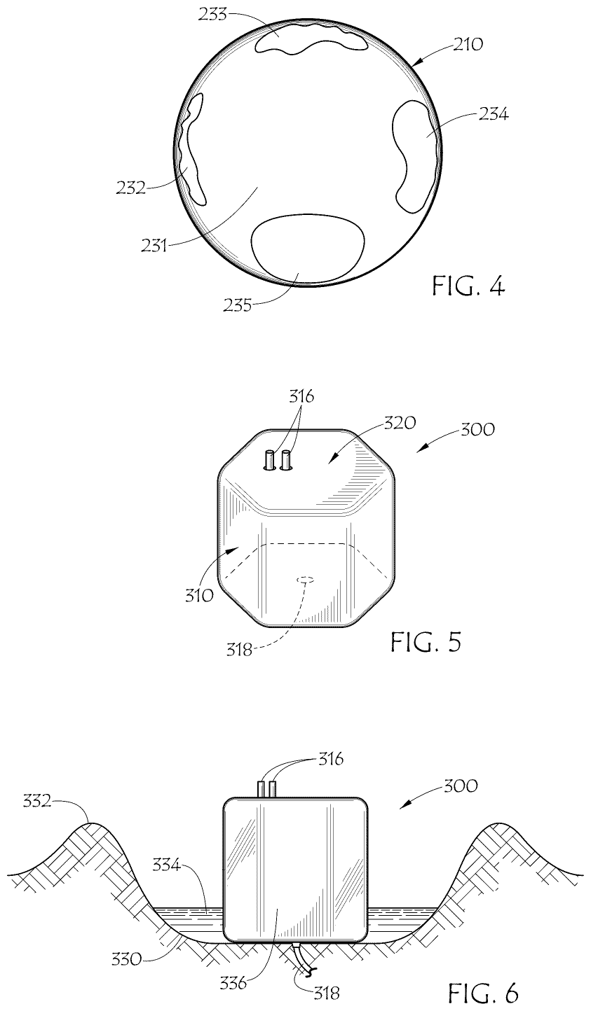

To further assure the integrity of the Brella and the Tipi, ballonets may be employed to minimize fatigue or other deleterious effects from the structure breathing as hydrogen is brought into or extracted from the Tipi/Brella system. Ballonets will do this by maintaining essentially constant the pressure of the Tipi/Brella system once the system has been brought up to pressure initially. Besides protecting the integrity of the Brella and the Tipi, keeping the storage pressure essentially constant will simplify the interface between the Tipi/Brella storage structure and the other elements of a power plant, the electrolyzers and the fuel cells. FIG. 4 illustrates the Brella 210 in cross section at the widest point, exposing four ballonets in various stages of inflation or pressurization residing in the interior 231 of the Brella 210. Ballonet 232 is not inflated at all, while ballonets 233 and 234 are partially inflated, and ballonet 235 is fully inflated.

It is expected that the ballonets will be made of the same light plastic as the Brella. They will be inside the Brella and using pressurized gas will be inflated and deflated as needed to maintain the pressure in the Brella. There is no pressure drop across the walls of the ballonets and so there will be no stress on them. They will fold and unfold and so will experience some fatigue, but since they simply sit inside the Brella, they will have minimal abrasion issues from rubbing against other surfaces as they expand or contract.

Ballonets are an innovative feature. Using ballonets, or alternatively the water-filling approach described below in the second embodiment, to maintain pressure may itself be novel. Although ballonets are used inside the Brella in the preferred embodiment described here, they are not required and are not a limitation on the system generally.

### Other Components

The Cistern 130 and the Solar Shell do not store hydrogen. They are, however, complementary elements of a power plant using the Tipi and Brella, and as part of that larger system they are described briefly here.

### The Cistern

The Tipi serves a secondary purpose as part of a water collection system. The Cistern 130 is the water collector and/or reservoir for that system. Cistern 130 includes a round depression in the ground in which the Tipi and the Brella may sit. Surrounding the Tipi is raised berm 132 (raised with respect to the surrounding ground level 134) which may offer some protection for the entire Tipi and increase the capacity of the Cistern. The Cistern may include a filtration system, and, except for the filtered inlet, it may be covered so as to reduce water loss through evaporation. Water outlet 118 may be provided to remove excess water collected.

Besides harvesting or storing the water which comes off the Solar Shell and Tipi, the Cistern may also provide pressure support for the bottom of Tipi. The figure shows the bottom of the Tipi touching the cistern at only one point, the center. In reality the Cistern can provide support as needed at any point across the bottom of the Tipi either through features built into the Cistern or support blocks placed as needed.

### The Solar Shell

The optional Solar Shell is a set of solar panels and supporting structure that may overlay or be mounted on the Tipi. The Solar Shell converts sunlight into electrical energy and it can be combined with supplemental arrays of solar panels nearby as needed. Thus, green energy can be provided to power associated system components, such as pumps, compressors, valves, an electrolyzer, fuel cell peripherals, and the like.

This hydrogen-storage invention and this plan for clean-energy power plants using hydrogen storage, was conceived through a prayer. In late 2021 a Northern Cheyenne woman prayed, “I claim that our past due electric bill be paid in full in Jesus name.” This woman was praying at Morning Star Baptist church in Lame Deer, Montana. She was praying not for her bill but for the $2,000 the church owed. The church wanted to convert one of its buildings into a men's rehab center and was prevented from doing so because of this overdue bill.

The Northern Cheyenne Tribal Council later agreed with the church that this was a worthy project and allocated $10,000 toward making it happen. One might say the prayer had been answered.

Jesus, however, loves to give His children more than they ask or even imagine. Here Jesus plans to transform indigent ratepayers into esteemed providers of electricity. And in the field of clean energy, He intends to transform the oppressed “least of these” into world restorers.

The Solar Shell is the remnant of a vision that Jesus might want the Northern Cheyenne and other Native Americans to build solar farms and harvest some of the solar energy which falls even on land deemed so useless as to be reserved by those who displaced them for the Indians they had conquered.

There are three reasons why the Solar Shell remains a important component in MorningStar power plants: (1) Solar Shells are desirable for plants connected to the grid. The independent ability to generate power may be important when negotiating for power purchase agreements. One may be disadvantaged if one is pure play energy storage, and must rely on others to supply the energy to be stored. (2) Solar Shells are necessary for plants not connected to the grid. Power plants that are not on the grid and have no neighboring power generators must have some means to generate energy. Solar is a good choice. (3) Solar Shells do double duty. The structure that supports the solar panels also reinforces the Tipi in withstanding the outward pressure of the hydrogen.

As stated above, potential usefulness of the invention is much broader than the details for the preferred embodiment presented above. In fact, although the title is a “Hydrogen Storage System,” it is a broader gas storage structure, and, as was stated above, even the hydrogen storage power plants for which this storage system is being developed, may use this same sort of structure to also store oxygen. The use of the term “Hydrogen” in the title is nonetheless appropriate since it highlights the motivation behind the invention and the key technology space of the initial users. Naming a specific gas also tends to avoid possible confusion between a gas and gasoline.

On Jun. 8, 2023, as the provisional patent disclosure was nearing completion the US government released the final version of its National Clean Energy Hydrogen Strategy and Roadmap. As was expected the paper targeted among other things, “building regional clean hydrogen hubs.” That is because it is accepted lore that you cannot build an above-ground hydrogen storage system that is cost competitive with storing hydrogen in salt caverns, which naturally leads to regional storage solutions. Here, we outline an invention which has the potential to turn that conventional wisdom on its head and may lead to universal local storage. The idea that hydrogen might be stored in bags at nearly ambient (atmospheric) pressure is not new. (See e.g., https://www.physicsforums.com/threads/low-pressure-hydrogen-storage.882963/) That hydrogen might be stored at high pressure in expensive structures, high-strength tanks, is also not new. Recognizing that it might be possible to build cost-competitive structures which could store large volumes of hydrogen at pressures between what an ordinary bag can contain and those typical of a high-pressure tank is novel. A particular embodiment, the Tipi, uses a skeletal structure and skin. While not designed for storage purposes, there are structures that contain roughly an atmosphere of pressure that do not have a skeletal structure (namely various types of sport balls). Using the kinds of materials and/or 3D printing methods described herein, embodiments may include a structure which would not generally be described as having a skeleton. Such an embodiment will be described below.

In broad terms, the first embodiment of the invention is considered a moderate-pressure, large-volume gas storage system. The key features are the following: (1) a gas storage system which stores large volumes of gas in a structure at relatively low pressures; (2) the gas-storage structure may include a Skeleton with a Skin; (3) the structure may be shaped like a tipi, called the “Tipi” herein; (4) the gas may be contained within an interior, collapsible bag or bladder, called the “Brella” herein; (5) the structure may be part of a water collection system; and (6) the structure may be part of (or incorporate) a solar power collection system. The low-cost, pressurized, gas-storage vessel of the invention may have a volume greater than 10 m³, or greater than 100 m³, or greater than 1000 m³, or greater than 10,000 m³, and may operate or store gases at a pressure ranging from 3 to 50 atmospheres, or from 5 to 30 atmospheres, or from 10 to 20 atmospheres, and functional between −40 and 100 degrees centigrade. The vessel may include a structural support skeleton and a impermeable covering or skin to withstand the pressure and to limit leakage of the stored gas.

As for the materials for the skin, it may include one or more layers of barrier film and one or more of said layers of reinforcement. The reinforcement may be a fabric and may be woven, knit, non-woven or of hybrid construction. As non-limiting examples, the base fabric may be square woven, weft and/or warp inserted knits, biaxial or triaxial constructions, or the like. The reinforcement is preferably puncture-, tensile- and tear-resistant and may be constructed from high tenacity yarn, such as polyester, nylon, carbon fiber, glass fiber and the like or combinations thereof. It is contemplated that the core need not be fabric and that any suitable generally planar reinforcing material may be used.

The base fabric layer may be coated with one or more penetrating, encapsulating, and/or adhesive coatings. Additional layers may then be laminated to the coated base fabric, including internal barrier layers, external protective layers, and the like. The layers may include barrier films such as polyolefin films, polyamide films, polyester films (including biaxially oriented PET films), EVOH films, metallic foils, and the like. Tougher outer layers may include thermoplastics such as polyethylenes, or other polyolefins, polyurethanes, polyvinylchloride, or thermoplastic elastomers, or elastomer or rubber layers, or blends or interpolymers or alloys of the foregoing. The two external face layers, a front coat and a back coat, may be of the same or different materials. Depending on the external layer composition, strips of the membrane materials may be joined to construct the vessels or pressurizable bladders described herein by various suitable joining techniques, including solvent, fusion, adhesive, or lamination processes. Examples of such multi-layer membrane constructions useful in this application are sold under the trademark XR-5 by Seaman Corporation. XR-5 membrane is currently available in two widths, 74-inch and 100-inch, on rolls about 250 yards long. This material has a weldable surface that can be joined or repaired without adhesive by welding the seams using either RF (radio frequency) welding or hot air. The material is also chemical and UV resistant.

For the Brella, the materials may again be multilayer barrier films, preferably with minimal or no fiber reinforcement for maximum flexibility. These films may be blown films or produced by any other suitable method.

### Second Embodiment

In a second embodiment, a major design motivation was to minimize pressure changes that might fatigue the membrane materials in the storage bladder. The concept is to fill and extract hydrogen gas from the top of the container and to fill and extract water from the bottom of the container so as to maintain a constant pressure in the bladder. The target pressure may be as stated above for the first embodiment. Based on the 800 psi strength rating of XR-5 material, a target pressure somewhere in the range of 120 to 150 psi would provide a 4× safety margin. In addition, the specified operating pressure for some electrolyzers and fuel cells are up to 150 psi or 125±10 psi. To the extent that we can simplify the whole system by not having to adjust pressures, the better. A water tower may be sufficient to provide the desired pressure simply by gravity. FIG. 5 is a rough sketch of a potential storage container 300 or cell. Hydrogen cell 300 includes top 320, bottom, and six sides 310. Thus, the cell may be hexagonal for efficient close-packing of multiple containers. The cell dimensions may be smaller than the large Tipi model described above. As a non-limiting example, the cell 300 may be about 50 feet high and about 50 feet side to side. Capacity may be increased by adding more cells. Each cell may have one or more gas ports 316 for adding or withdrawing hydrogen (or other gas being stored). Each cell may have one or more water ports 318 for adding or withdrawing water a the bottom of the container.

Note that there is some variation in the pressure at the bottom of the container from the added pressure of the weight of the water and the varying height of the water in the container. Also note that the flexible material of the container may bulge under internal pressure, thus more resembling a marshmallow than a regular hexagon.

The size of the container may be chosen based on the location constraints and the intended amount of gas needed. FIG. 6 shows the container 300 placed in an excavated hole 330 with berms 332 around it. Interior water 336 adjusts the volume for the gas and thus the pressure. Exterior water 334 may be at a similar level as interior water 336 to balance the weight of the water without creating a buoyancy effect on the container. With suitable tethers or restraints the entire container could be under water. In addition to the earthen barriers, having the container underwater makes it less visible and provides a measure of gross leak detection (bubbles).

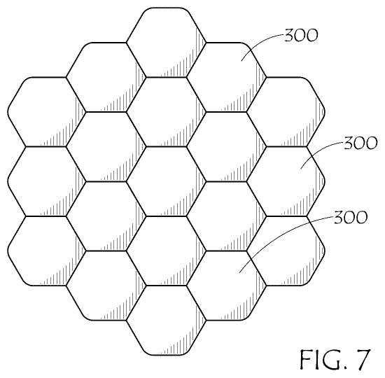

Compared to the largest version of the first embodiment, the relatively small size of the second embodiment container may also make handling easier and while it will use more material per volume, there may be cost savings from constructing a large number of smaller containers rather than a small number of large ones when trying to store larger volumes. The smaller volume containers also put less gas at risk should an individual container be breached. The hexagonal shape of the proposed container is to facilitate making a close packed field of containers to handle larger volumes, e.g., packing 19 containers 300 as shown in FIG. 7.

The sketch shows a hydrogen port at the top of the cell and a water port at the bottom of the cell in order to keep the hydrogen pressure constant as we store more and less hydrogen, In use, one would fill the cell 300 initially with water through water port 318 and its associated piping. Then, as hydrogen is introduced at the desired constant pressure through gas port 316, the water level would be lowered to accommodate more gas volume. Likewise, the water level would be increased again as the hydrogen is consumed. The pressure above the water could be held constant even though gas volume varies. The relatively modest pressure variations at the bottom of the cell should not substantially reduce the lifetime of the structure.

The size of the container is subject to change, but the limited height proposed here (50 feet or 16 m) is based on desire to have the container below the level of the surrounding ground for protection from the environment.

In both embodiments, the reservoirs or depressions may be lined with additional geomembranes to conserve water. The reservoirs may also be covered with membranes, e.g. to prevent water loss or to do distillation, to have really pure water as feedstock for the electrolyzers or for other uses. For example, the water in the reservoirs could also be used to cool the electrolyzers and fuel cells, which in turn keep the water warmer to help keep it from freezing on cold days.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A gas storage system which stores large volumes of a gas in a structure at a relatively low to moderate pressure ranging from about 3 atmospheres to about 50 atmospheres.

2. The gas storage system of claim 1 wherein the structure comprises a Skeleton with a Skin.

3. The gas storage system of claim 2 wherein the structure is shaped like a Tipi.

4. The gas storage system of claim 1 wherein the gas is contained within an interior, collapsible bladder.

5. The gas storage system of claim 1 wherein the structure is part of a water collection system.

6. The gas storage system of claim 2 wherein the Skin resides within the Skeleton.

7. The gas storage system of claim 2 wherein the Skin covers the Skeleton.

8. A low-cost, pressurized gas storage vessel with a volume greater than 10 m³ operating in a pressure range between 3 and 50 atmospheres and a temperature range between −40 and 100 degrees centigrade, which comprises a skin to contain the pressure and limit leakage of the stored gas.

9. The gas storage vessel of claim 8 wherein said skin comprises a flexible, multi-layer membrane.

10. The gas storage vessel of claim 9 wherein the membrane comprises one or more base fabric layers with one or more adhesive coatings, and one or more barrier layers.

11. The gas storage vessel of claim 10 wherein said base fabric layer comprises polyester yarn and is knit or woven or a hybrid construction.

12. The gas storage vessel of claim 10 wherein said coatings include an adhesive coat that penetrates and encapsulates the yarns.

13. The gas storage vessel of claim 10 further comprising one or more face layers wherein said face layers include a front coat and a back coat that employ a polyethylene interpolymer alloy that provides chemical and UV resistance and provides a weldable surface for joining and repair.

14. The gas storage vessel of claim 8 further comprising one or more ballonets which may be inflated to adjust the pressure within the vessel.

15. The gas storage vessel of claim 8 further comprising water injection system by which the pressure in the vessel may be adjusted to compensate for gas additions or withdrawals.
